(19) United States
(12) Patent Application Publication
(10) Pub. No.: US 2023/0255225 A1
(43) Pub. Date: Aug. 17, 2023

(54) MATERIAL DISPENSER DEVICE, SYSTEM AND METHOD

(71) Applicant: X ROBOTICS, INC., San Francisco, CA (US)

(72) Inventors: Denis Rodionov, San Francisco, CA (US); Roman Sharapov, San Francisco, CA (US)

(73) Assignee: X ROBOTICS, INC., San Francisco, CA (US)

(21) Appl. No.: 18/307,182

(22) Filed: Apr. 26, 2023

Related U.S. Application Data
(63) Continuation-in-part of application No. 17/475,293, filed on Sep. 14, 2021.

(51) Int. Cl. A23C 19/00; B01F 35/71; B01F 35/75; B01F 27/232; B01F 35/32; B01F 35/50

(52) U.S. Cl. CPC A23C 19/00; B01F 27/232; B01F 35/54; B01F 35/3204; B01F 35/7175; B01F 35/71731; B01F 35/754551; B01F 2101/11

(57) ABSTRACT

A base unit device for effective mixing and dispensing of a material, and for quick and efficient cleaning of all components. The base unit defines a base internal cavity, and a removable auger and a removable mixer each rotatably located in the base internal cavity. A mixer support ledge of the mixer can overlap an auger support ledge of the auger to prevent the auger from being withdrawn from the base unit when the mixer and the auger are operatively assembled with the base unit. The mixer can include a locking end featuring locking tabs that can engage with a surface of a sidewall of the base unit that defines a mixer bore, thereby locking the mixer and the auger in position during operation. The base unit can be utilized with a hopper defining a hopper internal cavity for storing the material and providing it to the base internal cavity.

### CROSS-REFERENCE TO RELATED APPLICATION

This application is a continuation-in-part under 35 U.S.C. §120 based upon co-pending U.S. Pat. application Serial No. 17/475,293 filed on Sep. 14, 2021, the entire contents of which is incorporated herein by reference.

### BACKGROUND

### Technical Field

In some aspects, the present technology relates to a material dispenser base or base unit device, system and method for use in connection with mixing and dispensing a material. In some aspects, the present technology relates to a material dispenser base or base unit utilized with a hopper for use in connection with mixing and dispensing a material. In other aspects, the present technology relates to a material dispenser and/or method of dispensing a material utilizing an auger and mixer system. In some other aspects, the present technology relates to methods associated with operating a dispenser device for mixing and dispensing a material. In yet other aspects, the present technology relates to a dispenser system for providing a material ingredient to an automatic food processing machine. In some other aspects, the present technology relates to a material dispenser and/or method for preparing a food for cooking.

### Background Description

Motorized and hand operated mixers and dispensers for mixing a material and/or applying a food product are known. These known dispensers are specifically utilized to deliver a food product, such as cheese, on to a pizza crust in the making of pizza. The dispensers typically include a single mixer in a cheese container or hopper that include large mixing blades that run at high torque. The mixing blades of these known dispensers can create sufficient friction with the cheese resulting in high heat that can melt the cheese in the dispenser, thereby making the dispenser unusable.

Many attempts have been executed to automatize restaurants. Most of it uses universal robotics in the process. For example, some known systems use robotic to move a pizza from dough press to ingredients dispenser and then to a carousel oven. However, these known robotic systems utilize inefficient, complex and high cost dispensers.

### SUMMARY

In view of the foregoing disadvantages inherent in the known types of material dispensing devices at least some embodiments of the present technology provides a novel dismountable material dispenser device, system and method, and overcomes one or more of the mentioned disadvantages and drawbacks of the prior art. As such, the general purpose of at least some embodiments of the present technology, which will be described subsequently in greater detail, is to provide a new and novel material dispenser device, system and method which has all the advantages of the prior art mentioned herein and many novel features that result in a material dispenser device, system and method which is not anticipated, rendered obvious, suggested, or even implied by the prior art, either alone or in any combination thereof.

According to one aspect, the present technology can include a material dispenser base for mixing and dispensing a material. The material dispenser base can include a base unit, an auger and a mixer. The base unit can include a base internal cavity defined therein. The material can be receivable in the base internal cavity. The auger can be rotatably located in the base internal cavity. The mixer can be rotatably located in the base internal cavity.

According to another aspect, the present technology can include a material dispenser base for mixing and dispensing a material. The material dispenser base can include a base unit, an auger and a mixer. The base unit can include a base internal cavity defined therein. The auger can be rotatably located in the base internal cavity. The auger can include an auger support end featuring an auger support ledge. The mixer can be rotatably located in the base internal cavity. The mixer can include a mixer support end featuring a mixer support ledge. The mixer support ledge can be configured to overlap the auger support ledge to prevent the auger from being withdrawn from the base unit when the mixer and the auger are operatively assembled with the base unit.

According to yet another aspect, the present technology can include a material dispenser base for mixing and dispensing a material. The material dispenser base can include a base unit, an auger and a mixer. The base unit can include a base internal cavity defined therein. The auger can be rotatably located in the base internal cavity. The mixer can be rotatably located in the base internal cavity. The mixer can include one or more paddles, and a locking end. The locking end can include one or more locking tabs extending out from the locking end. The locking tabs can be engageable with a sidewall of the base unit that defines a mixer bore when the locking tabs are received through the mixer bore.

According to still another aspect, the present technology can include a material dispenser base for mixing and dispensing a material. The material dispenser base can include a base unit, an auger and a mixer. The base unit can include a base internal cavity defined therein. The auger can be rotatably located in the base internal cavity. The auger can include an auger support end featuring an auger support ledge. The mixer can be rotatably located in the base internal cavity. The mixer can include a mixer support end featuring a mixer support ledge. The mixer support ledge can be configured to overlap the auger support ledge to prevent the auger from being withdrawn from the base unit when the mixer and the auger are operatively assembled with the base unit. The mixer can include one or more paddles extending out from the shaft, and a locking end. The locking end can include one or more locking tabs extending out from the locking end. The locking tabs can be engageable with a sidewall of the base unit that defines a mixer bore when the locking tabs are received through the mixer bore.

According to still yet another aspect, the present technology can include a method of operating a material dispenser base for mixing and dispensing a material. The material dispenser base can include a base unit defining a base internal cavity therein, an auger and a mixer. The method can include the steps of rotating the mixer to mix the material in the base internal cavity. Rotating the auger to advance at least as potion of the material out of the base internal cavity and dispensed out the base unit.

According to yet another aspect, the present technology can include a method of assembling a material dispensing base. The material dispenser base can include a base unit defining a base internal cavity therein, an auger and a mixer. The method can include the steps of inserting at least part of the auger through an auger bore defined through the base unit and into the base internal cavity. Inserting at least a portion of the mixer through a first mixer bore defined through the base unit and into the base internal cavity so that a locking tabs extending from a locking end of the mixer are engageable with a sidewall of the base unit or a second mixer bore defined through the sidewall.

According to still another aspect, the present technology can include a method of assembling a material dispensing base. The material dispenser base can include a base unit defining a base internal cavity therein, an auger and a mixer. The method can include the steps of inserting at least part of the auger through an auger bore defined through the base unit and into the base internal cavity. Inserting at least a portion of the mixer through a first mixer bore defined through the base unit and into the base internal cavity so that a mixer ledge of a mixer support end overlaps an auger ledge of an auger support end to prevent the auger from being withdrawn from the auger bore. The auger support end and the mixer support end both being exterior of the base unit.

According to one aspect, the present technology can include a material dispensing system for mixing and dispensing a material. The material dispensing system can include a hopper, a base unit, an auger and a mixer. The hopper can include a hopper internal cavity defined therein. The base unit can include a base internal cavity defined therein. The auger can be rotatably located in the base internal cavity. The mixer can be rotatably located in the base internal cavity.

Some embodiments of the present technology can include a hopper including a hopper internal cavity defined therein. The hopper internal cavity can be in communication with the base internal cavity.

In some embodiments, the hopper can be integrally formed with the base unit.

In some embodiments, the base unit defines an auger chamber in communication with the base internal cavity. The auger chamber can be configured to rotatably receive at least a part of the auger.

In some embodiments, the base unit defines a mixer chamber in communication with the base internal cavity. The mixer chamber is configured to rotatably receive at least a part of the mixer.

In some embodiments, the base unit can include a discharge end extending out therefrom. The discharge end defines a hollow interior therethrough that is in communication with the auger chamber.

In some embodiments, the discharge end can be configured to receive an auger discharge end of the auger. The auger can be configured to dispense the material from the auger chamber through the hollow interior of the discharge end.

In some embodiments, the auger can include an auger support end configured to support the auger in an auger bore defined through the base unit.

In some embodiments, the mixer can include a mixer support end configured to support the mixer in a mixer bore defined through the base unit.

In some embodiments, the auger support end can include an auger support ledge, and the mixer support end can include a mixer support ledge. The mixer support ledge can be configured to overlap the auger support ledge to prevent the auger from being withdrawn from the auger bore.

In some embodiments, the mixer can include a shaft, one or more paddles extending out from the shaft, and a locking end.

In some embodiments, the locking end can include one or more locking tabs extending out from the locking end.

In some embodiments, the locking tabs can be configured to engage with a sidewall of the base unit or a surface of the base unit that defines a mixer bore when the locking tabs are received through the mixer bore.

In some embodiments, the auger and the mixer each can include a cog or a cog socket that is operatively engageable with one or more motors or a gearbox.

In some embodiments, the mixer can be at least two mixers. At least a part of each of the at least two mixers can be rotatable receivable in a mixer chamber defined in the base unit. The at least two mixers can be located in a spaced apart relationship with each other in the base unit to create an opening therebetween configured to allow the material to pass therebetween toward the auger.

In some embodiments, the at least two mixers can be operatively driven in counter rotating directions by a motor or by a gearbox.

Some embodiments of the present technology can include a fastener. When the hopper is mounted to the base unit, the hopper internal cavity can be in communication with the base internal cavity, and the hopper and the base unit can be secured together by the fastener in a locked position.

In some embodiments, the hopper can be removed from the base unit, when the fastener is in an unlocked position.

In some embodiments, the mixer is configured to mix the material in the base internal cavity in an arc path towards the auger.

In some embodiments, the material can be a foodstuff.

In some embodiments, the foodstuff can be cheese.

There has thus been outlined, rather broadly, embodiments of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology.

It is therefore an object of the present technology to provide a new and novel material dispenser device, system and method that has all of the advantages of the prior art material dispensing devices and none of the disadvantages.

It is another object of the present technology to provide a new and novel material dispenser device, system and method that may be easily and efficiently manufactured and marketed.

An even further object of the present technology is to provide a new and novel material dispenser device, system and method that has a low cost of manufacture with regard to both materials and labor, and which accordingly is then susceptible of low prices of sale to the consuming public, thereby making such material dispenser device, system and method economically available to the buying public.

Still another object of the present technology is to provide a new material dispenser device, system and method that provides in the apparatuses and methods of the prior art some of the advantages thereof, while simultaneously overcoming some of the disadvantages normally associated therewith.

For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the claimed present technology is not limited to meeting most or all of the objects identified and that some embodiments of the present technology may meet only one such object or none at all.

### BRIEF DESCRIPTION OF THE DRAWINGS

The present technology will be better understood and objects other than those set forth above will become apparent when consideration is given to the following detailed description thereof. Such description makes reference to the annexed drawings wherein:

FIG. 1 is a top right perspective view of an embodiment of the material dispenser base or base unit device for mixing and dispensing material constructed in accordance with the principles of the present technology, with the phantom lines depicting environmental structure and forming no part of the claimed present technology.

FIG. 2 is a top elevational view of the material dispenser base or base unit device of FIG. 1

FIG. 3 is a top right perspective view of an embodiment of the material dispenser system constructed in accordance with the principles of the present technology including the material dispenser base of FIG. 1, with the phantom lines depicting environmental structure and forming no part of the claimed present technology.

FIG. 4 is a bottom left perspective view of the material dispenser system of FIG. 3.

FIG. 5 is an exploded perspective view of the material dispenser system of FIG. 3.

FIG. 6 is a cross-sectional perspective view of the hopper taken along line 6-6 in FIG. 5.

FIG. 7 is a cross-sectional perspective view of the base unit taken along line 7-7 in FIG. 5.

FIG. 8 is a cross-sectional view of the base unit taken along line 8-8 in FIG. 7.

FIG. 9 is a side plane view of the material dispenser device, system and method of the present technology.

FIG. 10 is a cross-sectional view of the auger taken along line 10-10 in FIG. 9.

FIG. 11 is a cross-sectional view of the auger taken along line 11-11 in FIG. 10.

FIG. 12 is a front plane view of one of the mixers of FIG. 5.

FIG. 13 is a rear plane view of the mixer of FIG. 12.

FIG. 14 is a cross- sectional view of view of the mixer taken along line 14-14 in FIG. 13.

FIG. 15 is a cross- sectional view of view of the mixer taken along line 15-15 in FIG. 14.

FIG. 16 is a cross-sectional view of the material dispenser system of FIG. 3.

FIG. 17 is a cross-sectional view of the material dispenser system taken along line 17-17 in FIG. 6.

FIG. 18 is a cross-sectional view of the material dispenser system taken along line 18-18 in FIG. 16.

FIG. 19 is a partial cross-sectional view of the mixer support ledge of the mixer support end overlapping the auger support ledge of the auger support end.

The same reference numerals refer to the same parts throughout the various figures.

### DETAILED DESCRIPTION OF THE EMBODIMENTS

Apart from the disadvantage and cumbersomeness of known dispensers, they are not easily capable of being disassembled for cleaning and/or repair, and they are not configured to provide sufficient mixing while reducing friction heat that can melt the material being mixed. If left uncleaned for a period of time, a foodstuff, such as cheese, in the hopper or cavities can begin to grow bacteria. Continued operation would then transfer the bacteria to a food item and thereafter eaten by the consumer. This causes an extremely dangerous health risk.

Furthermore, these known dispenser may have the ability to not thoroughly mix the foodstuff, allowing portions to clump together and even stick to the sidewalls of the hopper or mixing chamber. This causes failure of the dispenser to properly dispense the foodstuff or even clog the dispenser to a point that the internal mixing and/or dispensing components no longer operate.

The USDA says food that has been left out of the fridge for more than two hours should be thrown away. Consequently, these known food dispensers should be disassembled and cleaned every couple of hours. Further, it can take considerable time to disassembly these known pump dispensers for cleaning, which leads to down time of the food preparation machine causing loss of revenue.

While the above-described known devices fulfill their respective, particular objectives and requirements, the aforementioned devices or systems do not describe a material dispenser device, system and method that allows thorough mixing and dispensing a material. The present technology additionally overcomes one or more of the disadvantages associated with the known dispenser systems.

A need exists for a new and novel material dispenser device, system and method that can be used for mixing and dispensing a material. In this regard, the present technology substantially fulfills this need. In this respect, the material dispenser device, system and method according to the present technology substantially departs from the conventional concepts and designs of the prior art, and in doing so provides an apparatus primarily developed for the purpose of mixing and dispensing a material.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

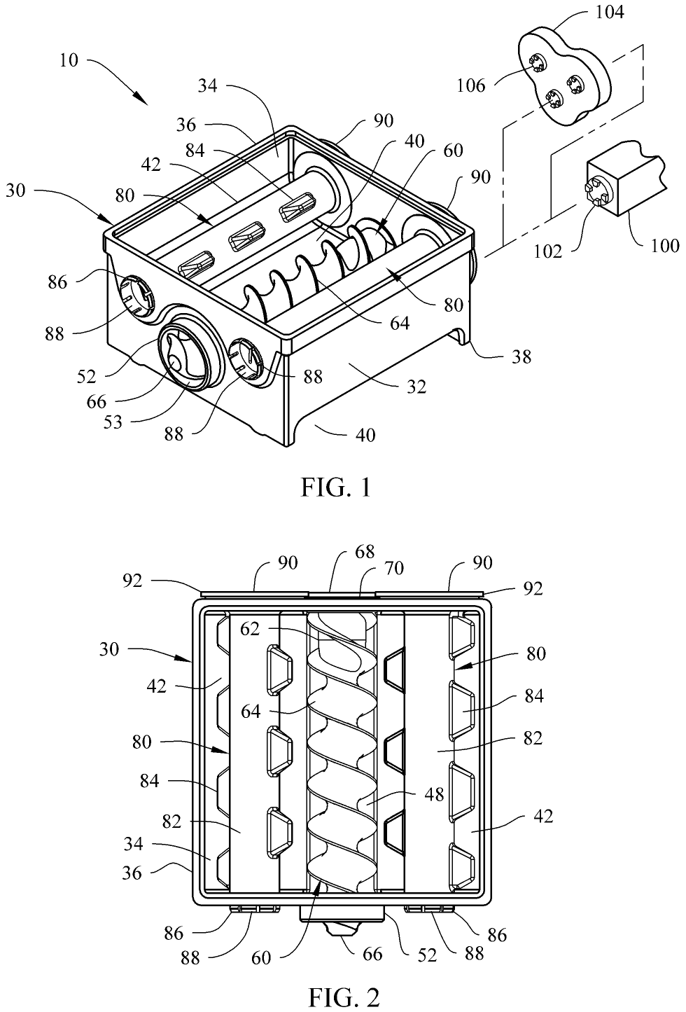

In an embodiment, a material dispenser base or base unit 10 is provided according to some aspects of the present technology for mixing and dispensing a material, as illustrated in FIGS. 1 and 2. In the exemplary, the material can be, but not limited to, a foodstuff, cheese, grains, nuts, pasta, fruits, vegetable, sauces, pastes, granule material, shredded material, and the like. Further in the exemplary, the material dispenser base or base unit 10 can be utilized to thoroughly mix the material in a manner to prevent the material from sticking together, clumping or coagulating.

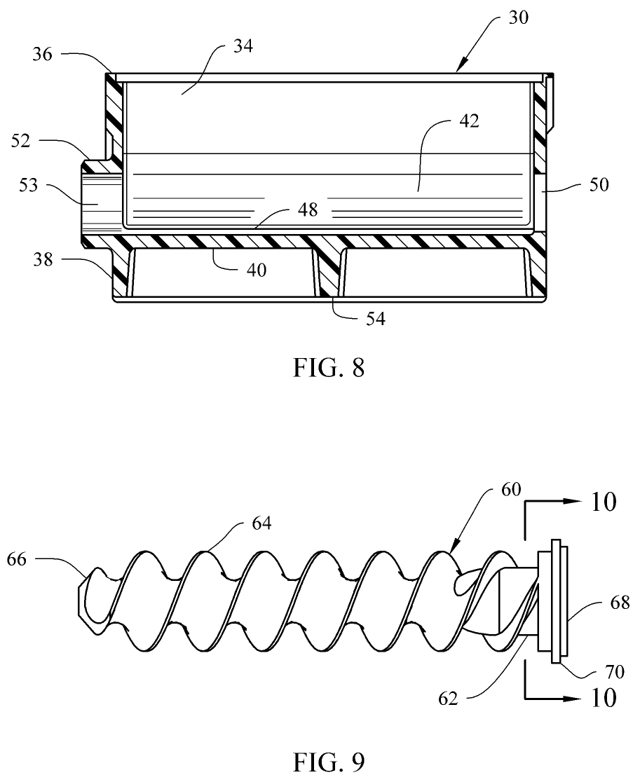

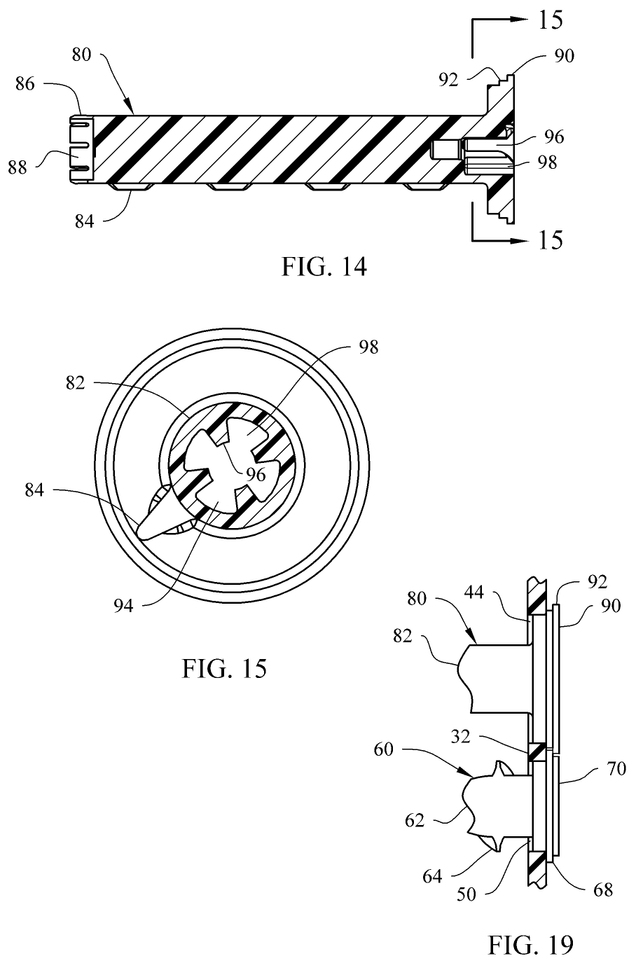

The material dispenser base or base unit base 10 can include, as best illustrated in FIGS. 1-5, 7-15 and 19, a base unit 30 for receiving, mixing and dispensing the material. The base unit 30 can utilize a removable feed auger 60 and one or more removable mixers 80. One or more motors 100 and/or a gearbox 104 can be utilized to drive the auger 60 and/or the mixers 80.

The base unit 30 can include an opened top body with sidewalls 32 and a bottom wall 40 that define a body internal cavity 34. The body internal cavity 34 is capable of receiving the material. The base unit 30 is configured to operatively and rotatably support the auger 60 and the mixers 80. The base unit 30 can be made of, but not limited to, plastic, metals, alloys, composites, any food grade material.

Feet 38 can extend from the sidewalls 32 or the bottom wall 40 for supporting the base unit 30 in an upright position, with hand gripping section or openings 39 being defined between the feet 38 or in any part of the sidewalls 32 or the bottom wall 40 of the base unit 30. The hand gripping sections 39 can be configured to be grasped by a user for manipulation of the material dispenser base or base unit 10. The hand gripping sections 39 can be an opening, notch, slot or the like defined between the feet 38 allowing fingers or a hand of the user to grasp the base unit 30.

The base unit 30 can include one or more mixer chambers 42 each configured in the base internal cavity 34 to rotatably receive at least a part of at least one of the mixers 80. In the exemplary, an embodiment can include two mixer chambers 42 defined along a longitudinal axis of the base unit 30 and located in the base internal cavity 34 at opposite sides of each other.

In an embodiment, an auger chamber 48 can be defined in the bottom wall 40 between and below the mixer chambers 42, as best illustrated in FIGS. 1, 2, 5, 7 and 8. The auger chamber 48 can be configured to rotatably receive at least a part of the auger 60.

A discharge end 52 can extend from the second sidewall of the base unit 30 opposite the auger bore 50. The discharge end 52 and can define a hollow interior 53 that is aligned with and in communication with the auger chamber 48.

The auger 60 can include an auger shaft 62 with one or more helically wound blades 64, the auger discharge end 66 and an auger support end 68. The auger discharge end 66 can be tapered or conical in configuration so as to have a width or diameter less than the blades 64. The auger discharge end 66 can be further configured to be receivable in the hollow interior 53 of the discharge end 52 of the base unit 30. The auger support end 68 can include an auger flanged or stepped ledge 70.

The mixers 80 can include a mixer shaft 82 featuring a plurality of paddles 84 extending out therefrom, a locking end 86 and a mixer support end 90. In an embodiment, the mixers 80 can be at least two mixers located between the hopper 12 and the auger 60. The mixers 80 can be located in a spaced apart relationship with each other in the base unit 30 to create an opening therebetween capable of allowing the material to pass therebetween toward or away from the auger 60.

The locking end 86 can include one or more locking tabs 88 extending out therefrom. The locking tabs 88 can have detents or bulges that extend past a width or diameter of the locking end 86 or the mixer shaft 82. In operation, the locking tabs 88 can be received through a mixer bore so that the bulges bend inwardly and pass about a surface of the sidewall that defines the mixer bore. Then, the locking tabs 88 can bias back to its original position, thereby rotatably retaining the mixer 80 in the mixer chamber 42. In an embodiment, the bulges of the locking tabs 88 prevent the mixer 80 from being withdrawn from the base unit 30 unless the locking tabs 88 are flexed inwardly by manually depression or by providing sufficient pulling force on the mixer 80 so that the locking tabs 88 are flexed inwardly upon contacting the surface of the sidewall that defines the mixer bore.

The mixer support end 90 can include a flanged or stepped ledge 92. The width or diameter of the mixer ledge 92 can be larger than the width or diameter of the auger ledge 70 of the auger support end 68, thereby allowing the mixer ledge 92 to overlap or engage with the auger ledge 70 of the auger support end 68 when the auger 60 and the mixer 80 are assembled with the base unit 30. When assembled, the auger support end 68 can be adjacent and exterior to the sidewall 32 with its auger ledge 70 located between the sidewall 32 and the mixer ledge 92 of the mixer 80, as best illustrated in FIGS. 2 and 19. With this configuration, the mixers 80 would inherently prevent the auger 60 from sliding out from the auger chamber 48.

In an embodiment, the base unit 30 can be a standalone unit configured to mix the material stored or received in the base internal cavity 34, and dispense the material from the base internal cavity 34.

In an embodiment, the discharge end 52 and its hollow interior 53 can be omitted allowing the base unit 30 to be used as a material mixer. In an embodiment, the discharge end 52 and its hollow interior 53, and the auger bore 50 and the auger 60 can be omitted allowing the base unit 30 to be used as a material mixer.

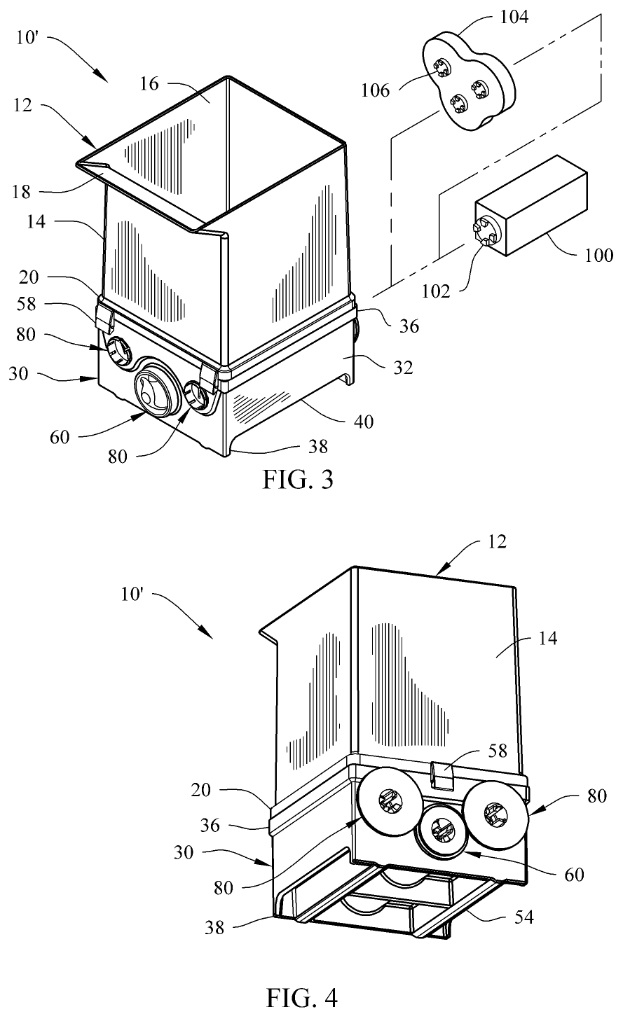

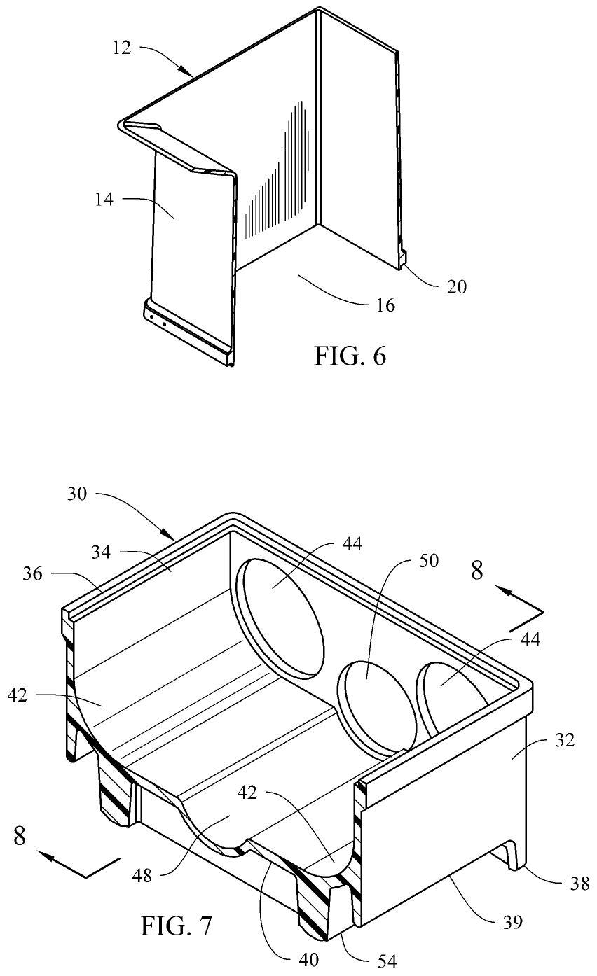

In an embodiment, the base unit 30 can be utilized as part of a material dispensing system 10′, as provided according to some aspects of the present technology for mixing and dispensing a material, as illustrated in FIGS. 3-19. In the exemplary, the material can be, but not limited to, a foodstuff, cheese, grains, nuts, pasta, fruits, vegetable, sauces, pastes, granule material, shredded material, and the like. Further in the exemplary, the material dispensing system 10′ can be utilized to thoroughly mix the material in a manner to prevent the material from sticking together, clumping or coagulating.

The material dispensing system 10′ can include the base unit 30 for receiving, mixing and dispensing the material, and a hopper 12. The base unit 30 can utilize the removable feed auger 60 and the one or more removable mixers 80. The hopper 12 can be utilized for storing the material, and providing the material to the base unit 30.

The material dispensing system 10′ can be configured to stir a material in at least the base unit 30 and in some case in both the base unit 30 and the hopper 12 so that the material does not stick together while lying for several hours. In some embodiments, the mixers 80 are configured to stir the material in different directions and after predefined time intervals, such as every few minutes. In the exemplary and not limited thereto, if the material is cheese, this interval mixing is advantageous as cheese has a sticky characteristic with a tendency to clump together and/or stick to surfaces and components in contact with the cheese. As cheese is quite a firm substance, the material dispensing system 10′ can be configured to enable very powerful mixing inside the base unit 30.

In an exemplary operation without limiting the scope of the present technology, the dispensing system 10′ can be configured to provide a material or foodstuff, such as cheese, to a food preparation machine that dispenses a dose of cheese on a pizza dough or other type of food. Further in the exemplary, the dispensing system 10′ can be utilized with or in a food preparation machine such as, but not limited to, an automated pizza making machine. In an embodiment, the dispensing system 10′ can be a module unit configured to be placed in different locations in a food preparation machine, and can include modular components for repair and/or upgrading to other components. In the exemplary, the dispensing system 10′ can be removably received in an automatic food processing machine, and can be configured to dispense the material on to a food article, for example but not limited to, a pizza crust supported below the dispensing system 10′.

In an embodiment, removal of the hopper 12 from the base unit 30, and removal of the auger 60 and the mixers 80 from the base unit 30 allows for easy cleaning and for unobstructed access to the interior of the base unit 30. The hopper 12, the base unit 30, the auger 60 and the mixers 80 can then be washed and cleaned by hand or can be placed in a dishwashing machine.

As best illustrated in FIGS. 3-6 and 15-18, an embodiment of the hopper 12 is configured to hold the material for dispensing out of the base unit 30 by way of the auger 60.

The hopper 12 includes a sidewalls 14 configured to create an internal hopper cavity 16 with an open top and bottom. The hopper 12 can be made of, but not limited to, plastic, metals, alloys, composites, and the like. One or more sides of the hopper 12 can include a funneled or angled top ledge 18 that may be used for ergonomics and handling of the hopper 12 and/or to assist in filling the hopper 12 with the material or emptying the hopper.

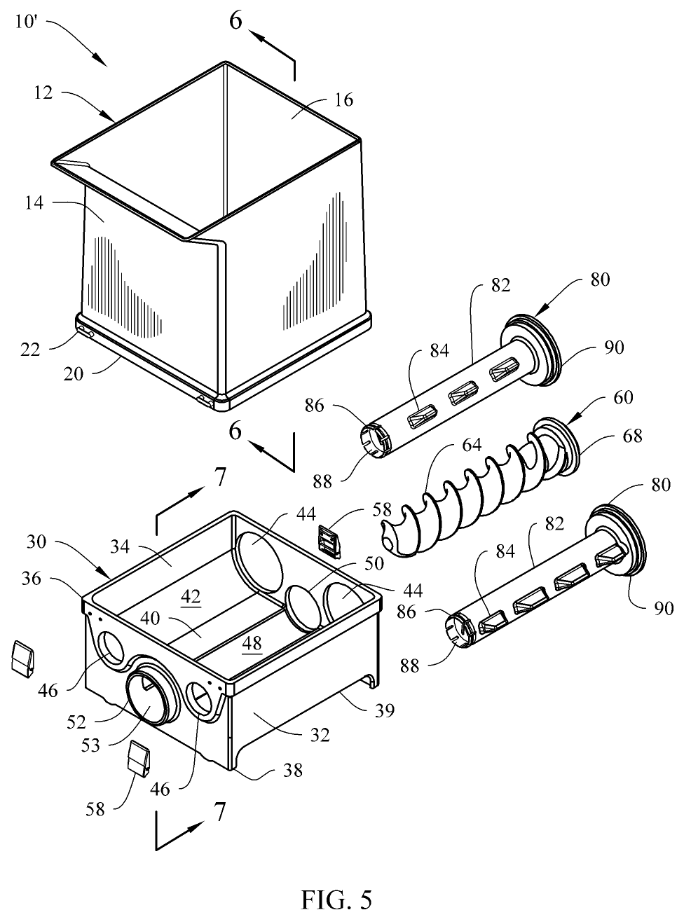

In the exemplary, the hopper 12 can include a bottom perimeter edge 20 featuring ridges, ledges, grooves, and the like for engaging or fitting with corresponding features of a top perimeter edge 36 of the base unit 30. This allows for removable attachment of the hopper 12 to a top side of the base unit 30, as best illustrated in FIG. 5. This further allows for guided assembly of the hopper 12 with the base unit 30.

The bottom perimeter edge 20 can further include bores, pegs, hooks, or latch receiving members or surfaces 22, that are configured to engage with a fastener 58 associated with the base unit 30. The fastener 58 and the surfaces 22 can be configured to secure the hopper 12 to the base unit 30. In the alternative, the fastener 58 can be associated with the sidewalls 14 or the bottom perimeter edge 20 of the hopper 12, with the surfaces 22 being associated with the base unit 30.

In an embodiment, the fastener 58 is a latch that can include a single or multiple pivoting mechanism that engages with the latch receiving surfaces 22, thereby allowing for the hopper 12 to be pulled toward the base unit 30 and locked in place. This pulling action by the latches 58 can further ensure a tight seal between the bottom perimeter edge 20 and the top perimeter edge 36 of the base unit. In an embodiment, this pulling action can be accomplished by, but not limited to, a threaded bolt or screw, or a threaded shaft and nut arrangement. In an embodiment, a seal or gasket (not shown) can be utilized between the bottom perimeter edge 20 and the top perimeter edge 36.

In an embodiment, the hopper 12 can be integrally formed with the base unit 30 to make a single hopper and base unit assembly.

One or more level or other sensors (not shown) can be utilized with any part of the hopper 12 to determine the amount or characteristic of the material in the hopper 12. Further, a lid or cover (not shown) can be utilized with covering the open end of the hopper 12.

Referring to FIGS. 1-5, 7, 8 and 16-18, the base unit 30 can include an opened top body with sidewalls 32 and a bottom wall 40 that define a body internal cavity 34 that is in communication with the hopper internal cavity 16 of the hopper 12 when assembled. The body internal cavity 34 is capable of receiving the material from the hopper internal cavity 16. The base unit 30 is configured to operatively and rotatably support the auger 60 and the mixers 80. The base unit 30 can be made of, but not limited to, plastic, metals, alloys, composites, any food grade material.

Feet 38 can extend from the sidewalls 32 or the bottom wall 40 for supporting the base unit 30 in an upright position, with hand gripping section or openings 39 being defined between the feet 38 or in any part of the sidewalls 32 or the bottom wall 40 of the base unit 30. The hand gripping sections 39 can be configured to be grasped by a user for manipulation of the material dispensing system 10′ or the base unit 30. The hand gripping sections 39 can be an opening, notch, slot or the like defined between the feet 38 allowing fingers or a hand of the user to grasp the base unit 30.

Reinforcing ribs 54 can be included with the bottom wall 40 of the pump unit 30 for providing rigidity and strength to the base unit 30 and/or for further support when placed on a surface, as best illustrated in FIGS. 4, 7 and 16. The feet 38 and/or the ribs 54 can be configured to allow the base unit 30 to be supported vertically on a surface or in a machine such as a food preparation machine. According to an embodiment, this allows for work to be performed on the base unit 30 more easily.

In an embodiment, the base unit 30 can include mounting brackets or members to secure the base unit 30 to a surface or in a machine. In an embodiment, the feet 38 can be slidably received in grooves defined in a support surface of a food preparation machine, thereby guiding and securing the base unit 30 in proper position for use in the food preparation machine.

The base unit 30 can include one or more mixer chambers 42 each configured in the base internal cavity 34 to rotatably receive at least a part of at least one of the mixers 80. In the exemplary, an embodiment can include two mixer chambers 42 defined along a longitudinal axis of the base unit 30 and located in the base internal cavity 34 at opposite sides of each other. The mixer chambers 42 have a profile that corresponds with at least a part of a profile of the mixers 80. In an embodiment, the mixer chambers 42 can be defined by a profile of an internal surface of the sidewalls 32 and/or the bottom wall 40 that defines the base internal cavity 34. This profile of the internal surface can correspond with a profile of the part of the mixer 80 receivable in the mixer chamber 42.

A first mixer bore 44 can be defined through a first sidewall of the base unit 30. The first mixer bore 44 can be aligned with and in communication with one of the mixer chambers 42. A second mixer bore 46 can be defined through a second sidewall of the base unit 30 opposite the first mixer bore 44. The second mixer bore 46 can be aligned with and in communication with the one of the mixer chambers 42. The first mixer bore 44 can be configured to rotatably receive at least a part of the mixers 80, while the second mixer bore 46 can be configured to rotatably receive at least a locking end 86 of the mixers 80.

In an embodiment, an auger chamber 48 can be defined in the bottom wall 40 between and below the mixer chambers 42, as best illustrated in FIGS. 5, 7 and 8. The auger chamber 48 can be configured to rotatably receive at least a part of the auger 60. An auger bore 50 can be defined through the first sidewall of the base unit 30. The auger bore 50 can be aligned with and in communication with the auger chamber 48. The auger bore 50 can be configured to rotatably receive at least a part of the auger 60.

A discharge end 52 can extend from the second sidewall of the base unit 30 opposite the auger bore 50. The discharge end 52 and can define a hollow interior 53 that is aligned with and in communication with the auger chamber 48. The auger bore 50 is configured to rotatably receive at least a part of the auger 60, while the hollow interior 53 is configured to rotatably receive at least an auger discharge end 66 of the auger 60. In an embodiment, the auger chamber 48 can be defined by a profile of an internal surface of the bottom wall 40 that defines the base internal cavity 34. This profile of the internal surface can correspond with a profile of the part of the auger 60 receivable in the auger chamber 48.

Referring to FIGS. 9-11, an embodiment of the auger 60 can include an auger shaft 62 with one or more helically wound blades 64, the auger discharge end 66 and an auger support end 68. In an embodiment, the auger discharge end 66 and the auger shaft 62 with the blades 64 can be received through the auger bore 50 of the base unit 30, and supported to rotated within the auger chamber 48. The auger discharge end 66 can be tapered or conical in configuration so as to have a width or diameter less than the blades 64. The auger discharge end 66 can be further configured to be receivable in the hollow interior 53 of the discharge end 52 of the base unit 30.

The auger support end 68 can include an auger flanged or stepped ledge 70 configured to have a width or diameter larger than the auger bore 50 to support the auger 60 with the auger bore 50 and to prevent the entire auger 60 from being inserted through the auger bore 50 and into the base internal cavity 34.

In an embodiment, the auger shaft 62, any part of the auger support end 68 or any part of the ledge 70 can be configured to support the auger 60 in a cantilevered position so that the blades 64 do not damage the surface of the bottom wall 40 that defines the auger chamber 48. In an embodiment, the blades 64 can rest on the surface of the bottom wall 40 that defines the auger chamber 48, thereby providing a contact seal for transferring the material in the auger chamber 48 to the discharge end 52.

In an embodiment, a bearing or bushing (not shown) can be utilized with the auger bore 50 and the auger shaft 62, any part of the auger support end 68 or any part of the ledge 70.

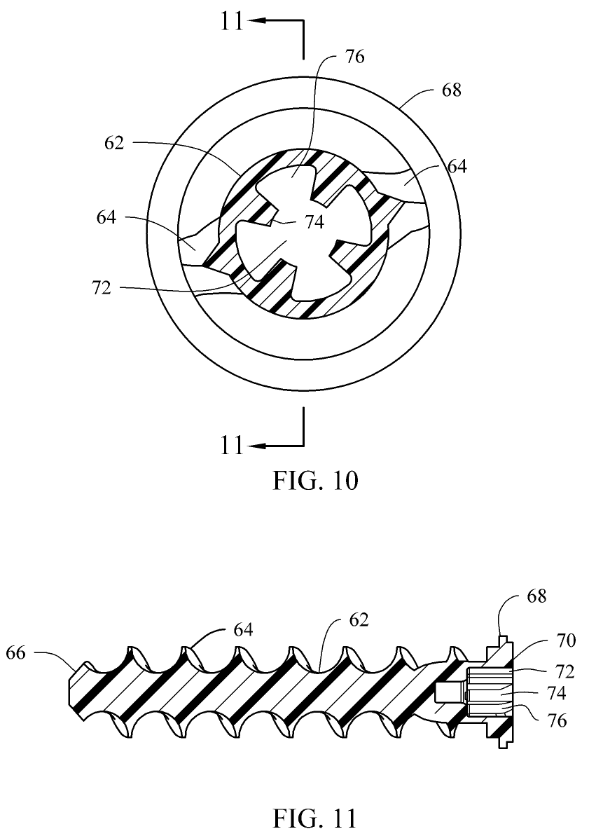

A cog or cog socket configuration, as best illustrated in FIGS. 10 and 11, can be defined in the auger support end 68 of the auger 60. This configuration can include an auger cog cavity 72 defined into the support end 68 with a plurality of cog teeth 74 extending into the cog cavity 72 while defining a gap 76 between each of the cog teeth 74. Each cog tooth 74 can be configured to be receivable in a corresponding gap of the cog or coupler 102, 106 of either the motor 100 or the gearbox 104. This configuration allows for disassembly of the motor 100 or the gearbox 104 from the base unit 30, and allows for the transfer of rotational motion from the motor 100 to the auger 60 to the auger 60 in any rotational direction.

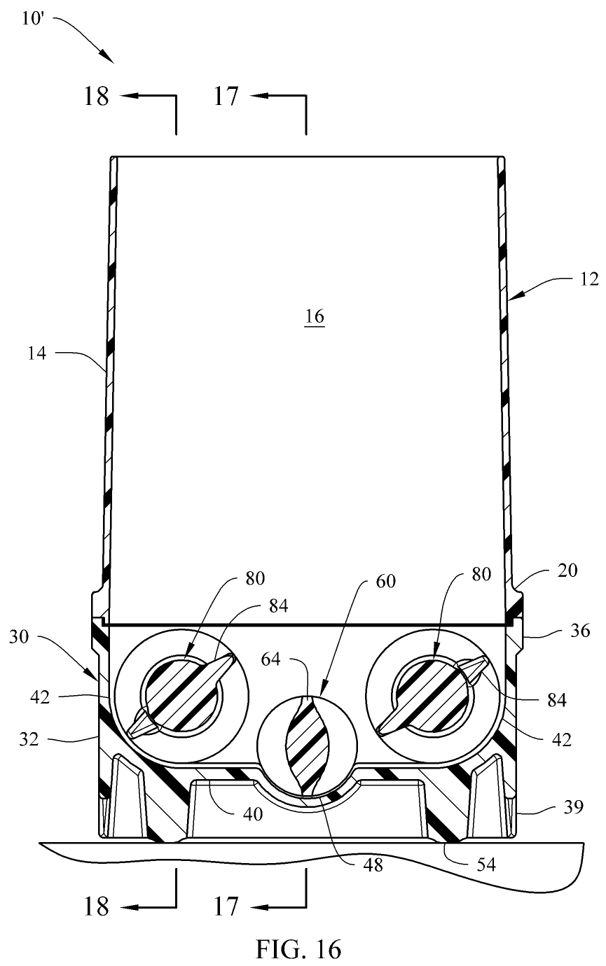

As best illustrated in FIG. 16, the auger chamber 48 can have a portion shaped to rotatably receive the blades 64 of the auger 60 therein, with an opened top that is in communication with the internal cavity 34. The material, such as shredded cheese, stored in the hopper 12 can inherently fall toward the auger chamber 48, while rotation of the auger 60 advances portions of the material from the hopper 12 and/or base internal cavity 34 toward and through the hollow interior 53 of the discharge end 52.

The discharge end 52 can extend from the base unit 30, and a pipe joint (not shown) can be attachable thereto for directing the advanced material from the base unit 30 for dispensing thereout or therebelow.

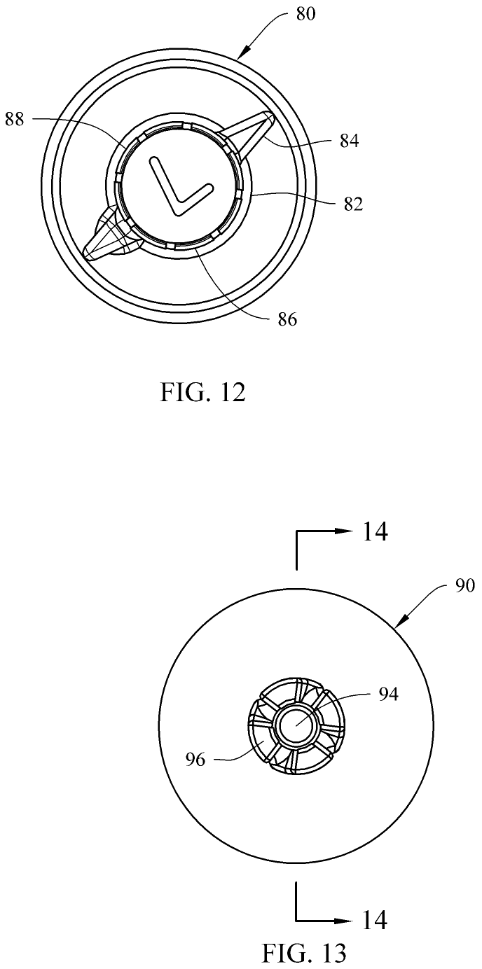

Referring to FIGS. 12-15, an embodiment of the mixers 80 can include a mixer shaft 82 featuring a plurality of paddles 84 extending out therefrom, the locking end 86 and a mixer support end 90. In an embodiment, the locking end 86 and the mixer shaft 82 with the paddles 84 can be received through the first mixer bore 44 of the base unit 30, and supported to rotate within the mixer chamber 42.

In an embodiment, the mixers 80 can be at least two mixers located between the hopper 12 and the auger 60. The mixers 80 can be located in a spaced apart relationship with each other in the base unit 30 to create an opening therebetween capable of allowing the material to pass therebetween toward or away from the auger 60.

The locking end 86 can include one or more locking tabs 88 extending out therefrom. The locking tabs 88 can have detents or bulges that extend past a width or diameter of the locking end 86 or the mixer shaft 82. In operation, the locking tabs 88 can be received through the second mixer bore 46 so that the bulges bend inwardly and pass about a surface of the sidewall that defines the second mixer bore 46. Then, the locking tabs 88 can bias back to its original position, thereby rotatably retaining the mixer 80 in the mixer chamber 42. In an embodiment, the bulges of the locking tabs 88 prevent the mixer 80 from being withdrawn from the base unit 30 unless the locking tabs 88 are flexed inwardly by manually depression or by providing sufficient pulling force on the mixer 80 so that the locking tabs 88 are flexed inwardly upon contacting the surface of the sidewall that defines the second mixer bore 46.

The mixer support end 90 can include a flanged or stepped ledge 92 configured to have a width or diameter larger than the first mixer bore 44, and can have a configuration capable of supporting the mixer 80 with the first mixer bore 44. In an embodiment, the mixer shaft 82, the locking end 86, any part of the mixer support end 90 and/or any part of the ledge 92 can be configured to support the mixer 80 so that the paddles 84 do not damage the surface of the bottom wall 40 or the sidewalls 32 that defines the mixer chamber 42.

In an embodiment, the paddles 84 can be in a spaced apart relationship with the surface of the bottom wall 40 or the sidewalls 32 that defines the mixer chamber 42, thereby providing a gap for the material in the base internal cavity 34 and/or the mixer chamber 42 to pass therethrough for increased mixing and/or passage toward the auger chamber 48 and/or the auger 60.

In an embodiment, the paddles 84 can contact the surface of the bottom wall 40 or the sidewalls 32 that defines the mixer chamber 42, to scrap away any material stuck to the sidewalls 32 or the bottom wall that defines the mixer chamber 42. Further, the paddles 84 can include flexible lips (not shown) that can contact the surface of the bottom wall 40 or the sidewalls 32 that defines the mixer chamber 42, to provide increased scrapping of the material. Still further, the paddles 84 can be a single paddle that spans the entire or almost the entire length of the mixer shaft 82.

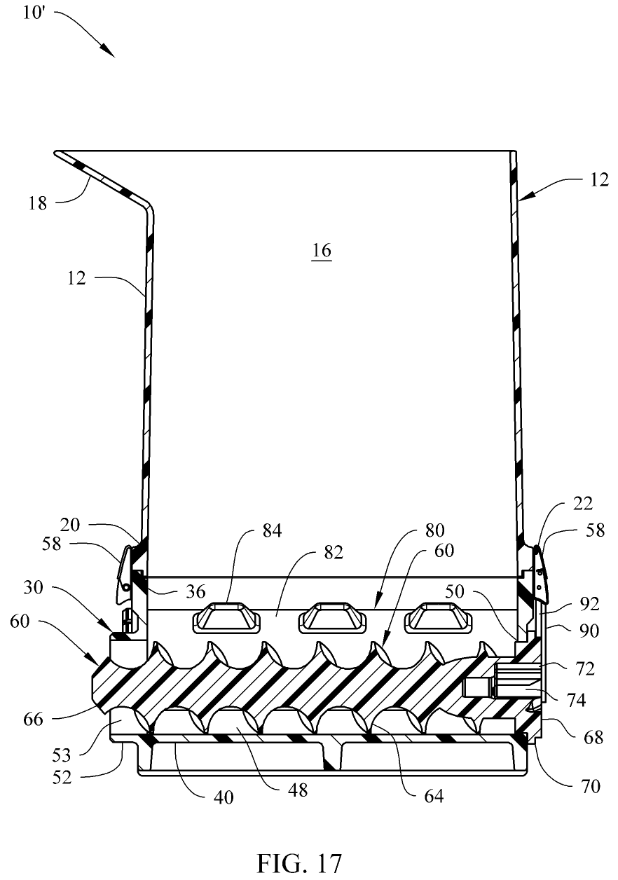

The width or diameter of the mixer ledge 92 can be larger than the width or diameter of the auger ledge 70 of the auger support end 68, thereby allowing the mixer ledge 92 to overlap or engage with the auger ledge 70 of the auger support end 68 when the auger 60 and the mixer 80 are assembled with the base unit 30. When assembled, the auger support end 68 can be adjacent and exterior to the sidewall 32 with its auger ledge 70 located between the sidewall 32 and the mixer ledge 92 of the mixer 80, as best illustrated in FIGS. 17 and 19. With this configuration, the mixers 80 would inherently prevent the auger 60 from sliding out from the auger chamber 48.

In an embodiment, a bearing or bushing (not shown) can be utilized with the first mixer bore 44, the mixer shaft 82, the locking end 86, any part of the mixer support end 90 or any part of the mixer ledge 92.

A cog or cog socket configuration, as best illustrated in FIGS. 13-15, can be defined in the mixer support end 90 of the mixer 80. This configuration can include a mixer cog cavity 94 defined into the mixer support end 90 with a plurality of cog teeth 96 extending into the mixer cog cavity 94 while defining a gap 98 between each of the cog teeth 96. Each cog tooth 96 is configured to be receivable in a corresponding gap of the cog or coupler 102, 106 of either the motor 100 or the gearbox 104. This configuration allows for disassembly of the motor 100 or the gearbox 104 from the base unit 30, and allows for the transfer of rotational motion from the motor 100 to any one of or any combination of the mixers 80 in any rotational direction.

A motor 100 can be utilized to operatively drive each of the auger 60 and the mixers 80 by way of a cog or coupler 102. Utilizing a motor 100 for each of or any combination of the auger 60 and mixers 80 can generate high torque required to mix a sticky material inside the hopper 12 and/or the base unit 30. It can be appreciated that any number of motors 100 can be utilized. In an embodiment, the auger 60 and mixers 80 can be operated manually.

Alternatively, one or more motors 100 can be operatively engaged with a gearbox 104 that includes a cog or coupler 106 associated and operatively engageable with any one of or any combination of the auger 60 and the mixers 80. In an embodiment, the gearbox 104 can be operatively engageable with any combination of just the mixers 80, while a separate motor 100 can be operatively engageable with the auger 60.

The cogs or couplers 102, 106 can be operably coupled to a corresponding cog or coupler of the auger 60 and mixers 80 exposed from a rear of the base unit 30, as best illustrated in FIG. 4.

In an embodiment, the gearbox 104 can include gears and/or clutches to independently and operatively engage any one of or any combination of the auger 60 and the mixers 80 with the motor 100.

In an embodiment, the mixers 80 can be driven separately from the auger 60, allowing for continued mixing of the material without dispensing the material.

By providing a powerful motor 100 and transmission gears in the gearbox 104 for both the mixer and auger operation, the dispensing system 10′ can be capable of dispensing many types of cheese, even if the cheese is melted or stuck somewhere in the hopper 12 or the base unit 30. Without this heavy mixer and auger set up, the cheese will stick within for example an hour, and it is not possible anymore to spread it.

FIGS. 16-18 illustrates the dispensing system 10′ as assembled and in an exemplary operation. When the base unit 30 is supported on a surface, a material stored in the hopper internal cavity 16 of the hopper 12 is directed towards the base internal cavity 34 of the base unit 30, and accordingly towards the mixers 80 and the auger 60. Upon activation of the motor 100 (see FIG. 3), the mixers 80 and the auger 60 begin to rotate in a predetermined rotational direction. For example, but not limited to, the mixers 80 can rotate in either counter rotational direction or the same rotational direction. Rotation of the mixers 80 provide agitation and mixing of at least a portion of the material. The paddles 84 and/or the profile of the mixer chambers 42 can provide an arc path of travel of the material in the base internal cavity 34. In an embodiment, the material can be directed towards or away from the auger chamber 48 by the arc path of the material and/or by the paddles 84 of the mixer 80.

This agitation of the material by the mixers 80 prevents the material from sticking to the interior surfaces of the hopper 12 and/or the base unit 30, and may further prevent clumping or coagulation of the material in the hopper 12 and/or in the base unit 30.

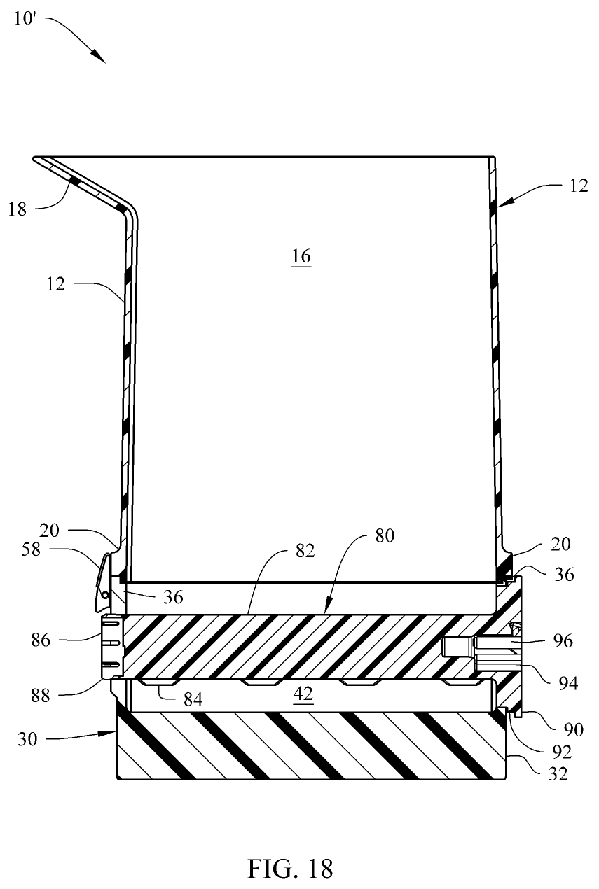

The material is provided to the auger 60 by way of the mixers 80 and/or gravity, as best illustrated in FIGS. 16 and 18, and is then advanced through the auger chamber 48 by way of the rotating auger 60, as best illustrated in FIG. 17. An inherent nature of the auger 60 can create pulses or sections of advancing material into the discharge end 52 and out the base unit 30.

In an embodiment, the mixers 80 can be replaced with augers, similar to the auger 60, that can provide mixing of the material by creating a flow path of the material different to that provided by the mixers 80.

When assembled, the auger support end 68 can be adjacent to the sidewall 32 with its auger ledge 70 located between the sidewall 32 and the mixer ledge 92 of the mixer 80, as best illustrated in FIG. 19. With this configuration, the mixers 80 would inherently prevent the auger 60 from sliding out from the auger chamber 48, while still allowing the auger 60 to rotate.

In an embodiment, the auger support end 68 or the auger ledge 70 can include a gear or gear teeth (not shown) that is operatively engageable with a corresponding gear or gear teeth included with the mixer support end 90 or the mixer ledge 92 of any one of or combination of the mixers 80. This configuration can inherently utilize a single motor 100 that is configured to operatively drive the auger 60 and the mixers 80.

In some embodiments, the material dispenser base 10 or the material dispensing system 10′ can be configured to operate in response to control signals providing by a computer system including at least one processing unit operably connected or connectable to a food preparation machine and/or to one or more sensors. The signals can correspond to the weight or other characteristics of the material, for example as detected by a weight/scale sensor (not shown), and then to vary the dispensing according to control signal.

According to one aspect, the present technology can include a material dispenser base or base unit 10 for mixing and dispensing a material. The material dispenser base 10 can include a base unit 30, an auger 60 and a mixer 80. The hopper 12 can include a hopper internal cavity 16 defined therein. The base unit 30 can include a base internal cavity 34 defined therein. The auger 60 can be rotatably located in the base internal cavity 34. The mixer 80 can be rotatably located in the base internal cavity 34.

According to still yet another aspect, the present technology can include a method of operating a material dispenser base 10 for mixing and dispensing a material. The material dispenser base 10 can include a base unit 30 defining a base internal cavity 34 therein, an auger 60 and a mixer 80. The method can include the steps of rotating the mixer 80 to mix the material in the base internal cavity 34. Rotating the auger 60 to advance at least as potion of the material out of the base internal cavity 34 and out of the base unit 30.

According to yet another aspect, the present technology can include a method of assembling a material dispenser base 10. The material dispenser base 10 can include a base unit 30 defining a base internal cavity 34 therein, an auger 60 and a mixer 80. The method can include the steps of inserting at least part of the auger 60 through an auger bore 50 defined through the base unit 30 and into the base internal cavity 34. Inserting at least a portion of the mixer 80 through a first mixer bore 44 defined through the base unit 30 and into the base internal cavity 34 so that a locking tabs 88 extending from a locking end 86 of the mixer 80 is engageable with a sidewall 32 of the base unit 30 or a second mixer bore 46 defined through the sidewall 32.

According to still another aspect, the present technology can include a method of assembling a material dispensing base 10. The material dispensing base 10 can include a base unit 30 defining a base internal cavity 34 therein, an auger 60 and a mixer 80. The method can include the steps of inserting at least part of the auger 60 through an auger bore 50 defined through the base unit 30 and into the base internal cavity 34. Inserting at least a portion of the mixer 80 through a first mixer bore 44 defined through the base unit 30 and into the base internal cavity 34 so that a mixer ledge 92 of a mixer support end 90 overlaps an auger ledge 70 of an auger support end 68 to prevent the auger 60 from being withdrawn from the auger bore 50. The auger support end 68 and the mixer support end 90 both being exterior of the base unit 30.

According to still yet another aspect, the present technology can include a material dispensing system 10′. The material dispenser system 10′ can include a hopper 12, a base unit 30, an auger 60 and a mixer 80. The hopper can include hopper 12 including a hopper internal cavity 16 defined therein. The base unit 30 can include a base internal cavity 34 defined therein. The auger 60 can be rotatably located in the base internal cavity 34. The mixer 80 can be rotatably located in the base internal cavity 34.

In some embodiments, the base unit 30 defines an auger chamber 48 in communication with the base internal cavity 34. The auger chamber 48 can be configured to rotatably receive at least a part of the auger 60.

In some embodiments, the base unit 30 defines a mixer chamber 42 in communication with the base internal cavity 34. The mixer chamber 42 can be configured to rotatably receive at least a part of the mixer 80.

In some embodiments, the base unit 30 can include a discharge end 52 extending out therefrom. The discharge end 52 defines a hollow interior 53 therethrough that is in communication with the auger chamber 48.

In some embodiments, the discharge end 52 can be configured to receive an auger discharge end 66 of the auger 60. The auger 60 can be configured to dispense the material from the auger chamber 48 through the hollow interior 53 of the discharge end 52.

In some embodiments, the auger 60 can include an auger support end 68 configured to support the auger 60 in an auger bore 50 defined through the base unit 30.

In some embodiments, the mixer 80 can include a mixer support end 90 configured to support the mixer 80 in a first mixer bore 44 defined through the base unit 30.

In some embodiments, the auger support end 68 can include an auger support ledge 70, and the mixer support end 90 can include a mixer support ledge 92. The mixer support ledge 92 can be configured to overlap the auger support ledge 70 to prevent the auger 60 from being withdrawn from the auger bore 50 .

In some embodiments, the mixer 80 can include a mixer shaft 82, one or more paddles 84 extending out from the shaft, and a locking end 86.

In some embodiments, the locking end 86 can include one or more locking tabs 88 extending out from the locking end 86.

In some embodiments, the locking tabs 88 can be configured to engage with a sidewall 32 of the base unit 30 or a surface of the base unit 30 that defines a second mixer bore 46. The second mixer bore 46 can be configured to receive therethrough the locking end 86 of the mixer 80.

In some embodiments, the auger 60 and the mixer 80 each can include a cog or a cog socket configuration 72, 74, 76, 94, 96, 98 that is operatively engageable with one or more motors 100 or a gearbox 104.

In some embodiments, the mixer 80 can be at least two mixers located between the hopper 12 and the auger 60. At least a part of each of the at least two mixers 80 can be rotatable receivable in a mixer chamber 42 defined in the base unit 30. The at least two mixers 80 can be located in a spaced apart relationship with each other in the base unit 30 to create an opening therebetween configured to allow the material to pass therebetween toward the auger 60.

In some embodiments, the at least two mixers 80 can be operatively driven by a motor 100 or by a gearbox 104 in counter rotating directions.

Some embodiments of the present technology can include a fastener 58. When the hopper 12 is mounted to the base unit 30, the hopper internal cavity 16 can be in communication with the base internal cavity 34, and the hopper 12 and the base unit 30 can be secured together by the fastener 58 in a locked position.

In some embodiments, the hopper 12 can be removed from the base unit 30, when the fastener 58 is in an unlocked position.

In some embodiments, the mixer 80 can be configured to mix the material in the base internal cavity 34 in an arc path towards the auger 60.

In some embodiments, the material dispenser system 10′ can comprise a computer system including at least one processing unit operably connected or connectable to the motor 100.

Some or all embodiments of the present technology can include a step of controlling an amount of the material dispensed from the dispenser 10′ on to a food item such as, but not limited to a pizza crust, by controlling the motor 100 based on any one of or any of data associated with the material, the material dispenser 10′, the food item, and the food preparation machine.

While embodiments of the material dispenser device, system and method have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable sturdy material may be used instead of the above-described. And although mixing and dispensing a material such as cheese has been described, it should be appreciated that the material dispenser device, system and method herein described is also suitable for mixing and dispensing any granule, shredded or pieced item.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

What is claimed as being new and desired to be protected by letters patent of the united states is as follows:

1. A material dispenser base for mixing and dispensing a material, the material dispenser base comprising:
a base unit including a base internal cavity defined therein, the material is receivable in the base internal cavity;
an auger rotatably located in the base internal cavity; and
a mixer rotatably located in the base internal cavity.

2. The material dispenser base according to claim 1, wherein the base unit defines an auger chamber in communication with the base internal cavity and a mixer chamber in communication with the base internal cavity, the auger chamber is configured to rotatably receive at least a part of the auger, the mixer chamber is configured to rotatably receive at least a part of the mixer.

3. The material dispenser base according to claim 2, wherein the base unit includes a discharge end extending out therefrom, the discharge end defines a hollow interior therethrough that is in communication with the auger chamber.

4. The material dispenser base according to claim 3, wherein the discharge end is configured to receive an auger discharge end of the auger, and the auger is configured to dispense the material from the auger chamber through the hollow interior of the discharge end.

5. The material dispenser base according to claim 1, wherein the auger includes an auger support end configured to support the auger in an auger bore defined through the base unit, and wherein the mixer includes a mixer support end configured to support the mixer in a mixer bore defined through the base unit.

6. The material dispenser base according to claim 5, wherein the auger support end includes an auger support ledge, wherein the mixer support end includes a mixer support ledge, and wherein the mixer support ledge is configured to overlap the auger support ledge to prevent the auger from being withdrawn from the auger bore.

7. The material dispenser base according to claim 1, wherein the mixer includes a shaft, one or more paddles extending out from the shaft, and a locking end.

8. The material dispenser base according to claim 7, wherein the locking end includes one or more locking tabs extending out from the locking end, wherein the locking tabs are engageable with a sidewall of the base unit or a surface of the base unit that defines a mixer bore when the locking tabs are received through the mixer bore.

9. The material dispenser base according to claim 1, wherein the auger and the mixer each includes a cog or a cog socket that is operatively engageable with one or more motors or a gearbox.

10. The material dispenser base according to claim 1, wherein the mixer is at least two mixers, at least a part of each of the at least two mixers being rotatable receivable in a mixer chamber defined in the base unit, the at least two mixers being located in a spaced apart relationship with each other in the base unit to create an opening therebetween configured to allow the material to pass therebetween toward the auger.

11. The material dispenser base according to claim 10, wherein the at least two mixers are operatively driven in counter rotating directions by a motor or by a gearbox.

12. The material dispenser base according to claim 1 further comprising a hopper including a hopper internal cavity defined therein, the hopper internal cavity being in communication with the base internal cavity.

13. The material dispenser base according to claim 12, wherein the hopper is integrally formed with the base unit.

14. The material dispenser base according to claim 12 further comprising a fastener, wherein, when the hopper is mounted to the base unit, the hopper internal cavity is in communication with the base internal cavity, and the hopper and the base unit are secured together by the fastener in a locked position, and wherein, when the hopper is removed from the base unit, the fastener is in an unlocked position.

15. The material dispenser base according to claim 1, wherein the material is a foodstuff.

16. The material dispenser base according to claim 15, wherein the foodstuff is cheese.

17. A material dispenser base for mixing and dispensing a material, the material dispenser comprising:
a base unit including a base internal cavity defined therein;
an auger rotatably located in the base internal cavity, the auger including an auger support end featuring an auger support ledge; and
a mixer rotatably located in the base internal cavity, the mixer including a mixer support end featuring a mixer support ledge;
wherein the mixer support ledge is configured to overlap the auger support ledge to prevent the auger from being withdrawn from the base unit when the mixer and the auger are operatively assembled with the base unit.

18. The material dispenser base according to claim 17, wherein the base unit further comprising:
an auger chamber defined in the base unit in communication with the base internal cavity, the auger chamber is configured to rotatably receive at least a part of the auger;
a mixer chamber defined in the base unit in communication with the base internal cavity, the mixer chamber is configured to rotatably receive at least a part of the mixer; and
a discharge end extending out therefrom, the discharge end defines a hollow interior therethrough that is in communication with the auger chamber;
wherein the discharge end is configured to receive an auger discharge end of the auger, and the auger is configured to dispense the material from the auger chamber through the hollow interior of the discharge end.

19. The material dispenser base according to claim 17, wherein the mixer includes a shaft, one or more paddles extending out from the shaft, and a locking end, the locking end includes one or more locking tabs extending out from the locking end, and wherein the locking tabs are engageable with a sidewall of the base unit that defines a mixer bore when the locking tabs are received through the mixer bore.

20. The material dispenser base according to claim 17, wherein the mixer is at least two counter rotating mixers, and wherein the at least two mixers being located in a spaced apart relationship with each other in the base unit to create an opening therebetween configured to allow the material to pass therebetween toward the auger.

21. The material dispenser base according to claim 17 further comprising a hopper including a hopper internal cavity defined therein, wherein the base internal cavity is in communication with the hopper internal cavity.

22. A material dispenser base for mixing and dispensing a material, the material dispenser comprising:
a base unit including a base internal cavity defined therein;
an auger rotatably located in the base internal cavity; and
a mixer rotatably located in the base internal cavity, the mixer including one or more paddles, and a locking end, the locking end including one or more locking tabs extending out from the locking end;
wherein the locking tabs are engageable with a sidewall of the base unit that defines a mixer bore when the locking tabs are received through the mixer bore.
